(19) United States
(12) Patent Application Publication
(10) Pub. No.: US 2008/0122701 A1
(43) Pub. Date: May 29, 2008

(54) Multi-Band Planar Inverted-F Antenna

(75) Inventors: Ching-Neng Kan, Taoyuan County (TW); Hsuan-Yi Kuo, Taoyuan County (TW); Hsien-Chen Dai, Taoyuan County (TW); Yi-Hung Chang, Taoyuan County (TW)

Correspondence Address: WPAT, PC, 7225 BEVERLY ST., ANNANDALE, VA, 22003, US

(73) Assignee: KINSUN INDUSTRIES INC., Taoyuan County (TW)

(21) Appl. No.: 11/686,116

(22) Filed: Mar. 14, 2007

(30) Foreign Application Priority Data
Nov. 28, 2006 (TW) 095220914

(51) Int. Cl. H01Q 9/04

(52) U.S. Cl. 343/700 MS

(57) ABSTRACT

A multi-band planar inverted-F antenna, adapted for a wireless communication device, is disclosed, which is comprised of: a feeding port, a first radiation area, a second radiation area, a ground area and a connecting port. The wireless communication device is connected to the feeding port through a signal line so as to transmit/receive signal using the antenna. The first and the second radiation areas are connected to the feeding port while being arranged at a same side with respect to the feeding port. The connecting port, being connected to the ground area, is connected to the feeding port while being arranged at a side opposite to the first radiation area with respect to the feeding port. As the structure of the aforesaid multi-band planar inverted-F antenna is simple, it is easy to be manufactured.

### FIELD OF THE INVENTION

The present invention relates to a multi-band antenna, and more particularly, to a multi-band planar inverted-F antenna.

### BACKGROUND OF THE INVENTION

With rapid advance of communication technology, the applications of wireless communication have been increased significantly in recent years which have made wireless communication device being extensively applied in consumer electronic products, such as notebook computers, cellular phones, personal digital assistants (PDAs), and so on. Conventionally, the wireless communication device is designed to be housed inside such consumer electronic products for aesthetic reason and thus it is required to be connected to internal antennas for enabling the same to perform an intended wireless data transmission operation. There are many kinds of internal antennas currently available, such as micro-strip antenna, planar inverted-F antenna (PIFA), planar helical antenna, etc. Among which, the planar inverted-F antenna is most preferred for its comparatively smaller size, uncomplicated structure, easier to be designed and constructed, and so on.

One such popular planar inverted-F antenna (PIFA) is the dual-band planar inverted-F antenna disclosed in TW pat. No. 563274. However, the transmission efficiency of the dual-band planar inverted-F antenna is poor since the feed location of the antenna is changed causing the input impedance of the antenna to change accordingly. In addition, the structure of the aforesaid dual-band planar inverted-F antenna is comparatively complicated that it is difficult to adjust its impedance matching and thus the gain of such antenna is reduced substantially.

### SUMMARY OF THE INVENTION

In view of the disadvantages of prior art, the primary object of the present invention is to provide a multi-band planar inverted-F antenna that is simple in structure and ease to adjust impedance matching.

To achieve the above object, the present invention provides a multi-band planar inverted-F antenna, adapted for a wireless communication device, which is comprised of: a feeding port, a first radiation area, a second radiation area, a ground area and a connecting port. The wireless communication device is connected to the feeding port through a signal line so as to transmit/receive signal using the antenna. The first and the second radiation areas are connected to the feeding port while being arranged at a same side with respect to the feeding port. The connecting port, being connected to the ground area, is connected to the feeding port while being arranged at a side opposite to the first radiation area with respect to the feeding port.

Preferably, the connecting port is connected to a corner of the ground area.

Preferably, the length of the first radiation area can be equal to that of the second radiation area, or is not equal to.

Preferably, the width of the first radiation area can be equal to that of the second radiation area, or is not equal to.

Preferably, the first radiation area can be designed with various widths, and the same to the second radiation area.

In a preferred embodiment of the invention, the multi-band planar inverted-F antenna further comprises: a third radiation area, connected to the feeding port while arranged at a side the same as that of the first radiation area with respect to the feeding port.

To sum up, the structure of the aforesaid multi-band planar inverted-F antenna is simple and thus it is easy to be manufactured. In addition, the impedance matching between the feeding port and the connecting port can be adjusted easily for enabling the antenna to have better receiving quality.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic diagram illustrating a multi-band planar inverted-F antenna according to a first preferred embodiment of the invention.

FIG. 2A˜FIG. 2C are schematic diagrams showing various multi-band planar inverted-F antennas according to the first preferred embodiment of the invention.

FIG. 3 is a schematic diagram illustrating a multi-band planar inverted-F antenna according to a second preferred embodiment of the invention.

FIG. 4A shows the voltage standing-wave ratio of the multi-band planar inverted-F antenna of FIG. 1.

FIG. 4B shows the return loss of the multi-band planar inverted-F antenna of FIG. 1.

FIG. 5A shows the radiation pattern of H-plane multi-band planar inverted-F antenna of FIG. 1, operating at 2450 MHz.

FIG. 5B shows the radiation pattern of E-plane multi-band planar inverted-F antenna of FIG. 1, operating at 2450 MHz.

FIG. 6A shows the radiation pattern of H-plane multi-band planar inverted-F antenna of FIG. 1, operating at 5800 MHz.

FIG. 6B shows the radiation pattern of E-plane multi-band planar inverted-F antenna of FIG. 1, operating at 5800 MHz.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

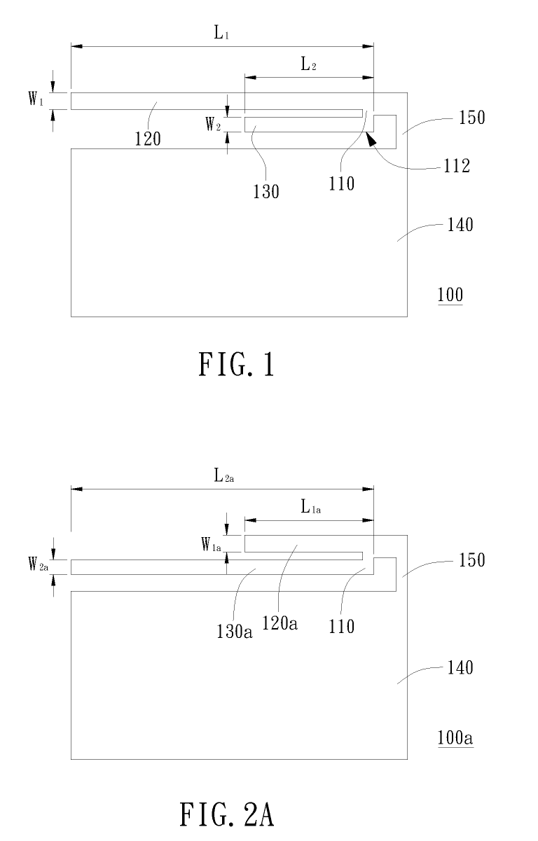

Please refer to FIG. 1, which is a schematic diagram illustrating a multi-band planar inverted-F antenna according to a first preferred embodiment of the invention. In FIG. 1, a multi-band planar inverted-F antenna 100, adapted for a wireless communication device, is disclosed, which is comprised of: a feeding port 110, a first radiation area 120, a second radiation area 130, a ground area 140 and a connecting port 150. The wireless communication device is connected to the feeding port 110 through a signal line so as to transmit/receive signal using the antenna 100. The first radiation area 120, the second radiation area and the connecting port 15 are all connected to the feeding port 110 in a manner that the first and the second radiation areas 120, 130 are arranged at a same side with respect to the feeding port 110, while the connecting port 150 is arranged at a side opposite to the first and the second radiation areas 120, 130 with respect to the feeding port 110. In addition, the connecting port is connected to the ground area 140 in a manner that the connecting port 150 is sandwiched between the feeding port 110 and the ground area 140.

Thus, as the structure of the aforesaid multi-band planar inverted-F antenna 100 is simple, it is easy to be manufactured by stamping and cutting with high yield. Moreover, as the signal line of the wireless communication device is connected to an end point 112 of the feeding port 110, the reception quality thereof is improved. In addition, as the connecting port 150 is connected to a corner of the ground area 140, ground areas 140 designed with different dimensions will cause the resulting antenna to operate at different bands.

In the first embodiment shown in FIG. 1, the length and width of the first radiation area 120 is represented as L₁ and W₁, and the length and width of the second radiation area 130 is represented as L₂ and W₂, whereas the dimensions of the first and the second radiation areas 120, 130 are dependent and determined by the intended transmission/reception frequency of the antenna 100. Moreover, the impedance matching can be optimized by the adjusting of the dimensions of the feeding port 110 and the connecting port 150 as well as the adjusting of the distance between the two. That is, the impedance matching between the feeding port 110 and the connecting port 150 can be adjusted easily so that the current flowing through the first and the second radiation areas 120, 130 can be control accurately for minimizing the interference, and thus the transmission quality of the multi-band planar inverted-F antenna 100 is improved.

Although the dimensions of the first and the second radiation areas 120, 130 are dependent and determined by the intended transmission/reception frequency of the antenna 100, the shapes of the two radiation areas 120, 130 are not restricted thereby. That is, the lengths of the two radiation areas 120, 130, i.e. L₁ and L₂, as well as the widths of the two radiation areas 120, 130, i.e. W₁ and W₂, can be designed according to actual requirement. Preferably, the first radiation area 120 can be designed with various widths, and the same to the second radiation area 130.

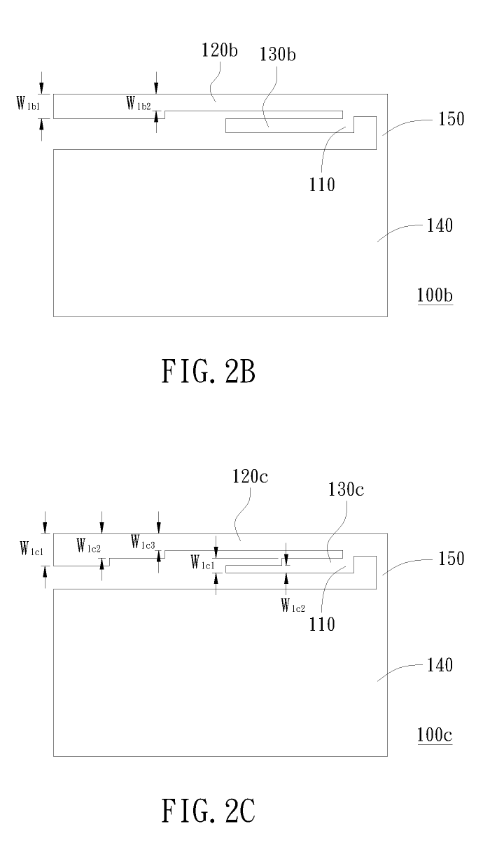

Please refer to FIG. 2A to FIG. 2C, which are schematic diagrams showing various multi-band planar inverted-F antennas according to the first preferred embodiment of the invention. In FIG. 2A, a multi-band planar inverted-F antenna 100a similar to that shown in FIG. 1 is illustrated. The difference between the two multi-band planar inverted-F antennas is that: in the multi-band planar inverted-F antenna 100a, the width W₁ₐ of the first radiation area 120a is not equal to the width W₂ₐ of the second radiation area 130a. Preferably, the width W₁ₐ of the first radiation area 120a is larger than the width W₂ₐ of the second radiation area 130a. However, it is noted that the width W₂ₐ of the first radiation area 120a can be smaller than the width W₂ₐ of the second radiation area 130a. In addition, the length L₁ₐ of the first radiation area 120a is smaller than the length L₂ₐ of the second radiation area 130a.

In FIG. 2B, the first radiation area 120b of the multi-band planar inverted-F antenna 100b is designed to be composed of two portions of different widths, i.e. W_{1ba}≠W_{1b2}. On the other hand, instead of designing the first radiation area 120b to be composed of two portions of different widths, the second radiation area 130b can be designed to be composed of two portions of different widths. Furthermore, as seen in the multi-band planar inverted-F antenna 100c shown in FIG. 2C, the first radiation area 120b of the multi-band planar inverted-F antenna 100b is designed to be composed of three portions of different widths, i.e. W_{1c1}, W_{1c2}, W_{1c3} are not equal to each other, while the first radiation area 120c is designed to be composed of two portions of different widths, i.e. W_{2ca}≠W_{2c2}.

It is emphasized that although the portions used for making up the first and the second radiation areas shown in FIG. 2A˜FIG. 2C are all rectangles, they are not limited thereby and thus can be shaped as any geometrical shape. Moreover, by designing additional radiation areas, the multi-band planar inverted-F antenna of the invention can be enabled to respond to more frequencies.

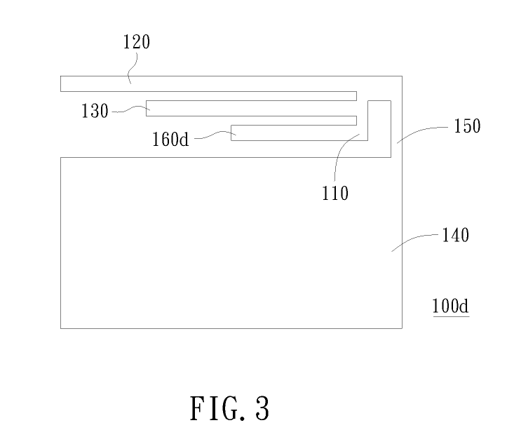

Please refer to FIG. 3, which is a schematic diagram illustrating a multi-band planar inverted-F antenna according to a second preferred embodiment of the invention. In FIG. 3, a multi-band planar inverted-F antenna 100d similar to that shown in FIG. 1 is illustrated. The difference between the two multi-band planar inverted-F antennas is that: the multi-band planar inverted-F antenna 100d is designed with an additional third radiation area 160d, that the third radiation area 160d is connected to the feeding port while arranged at a side the same as that of the first radiation area 120 or the second radiation area 120 with respect to the feeding port 110. The multi-band planar inverted-F antenna 100d is able to receive/transmit electromagnetic waves of three different frequencies. Thus, the number of the radiation areas to be designed in the antenna is determined by the frequencies that are intended to be received/transmitted thereby.

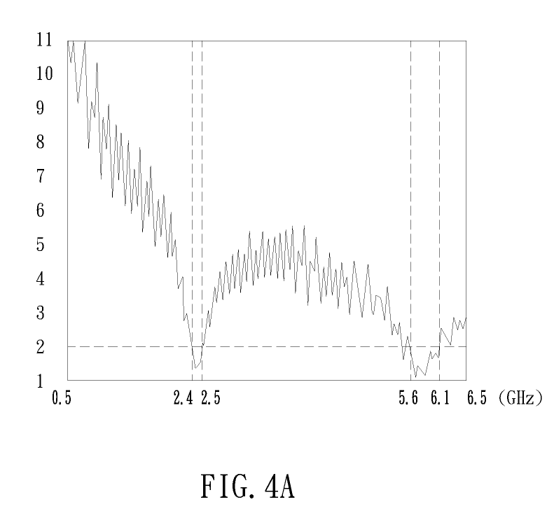

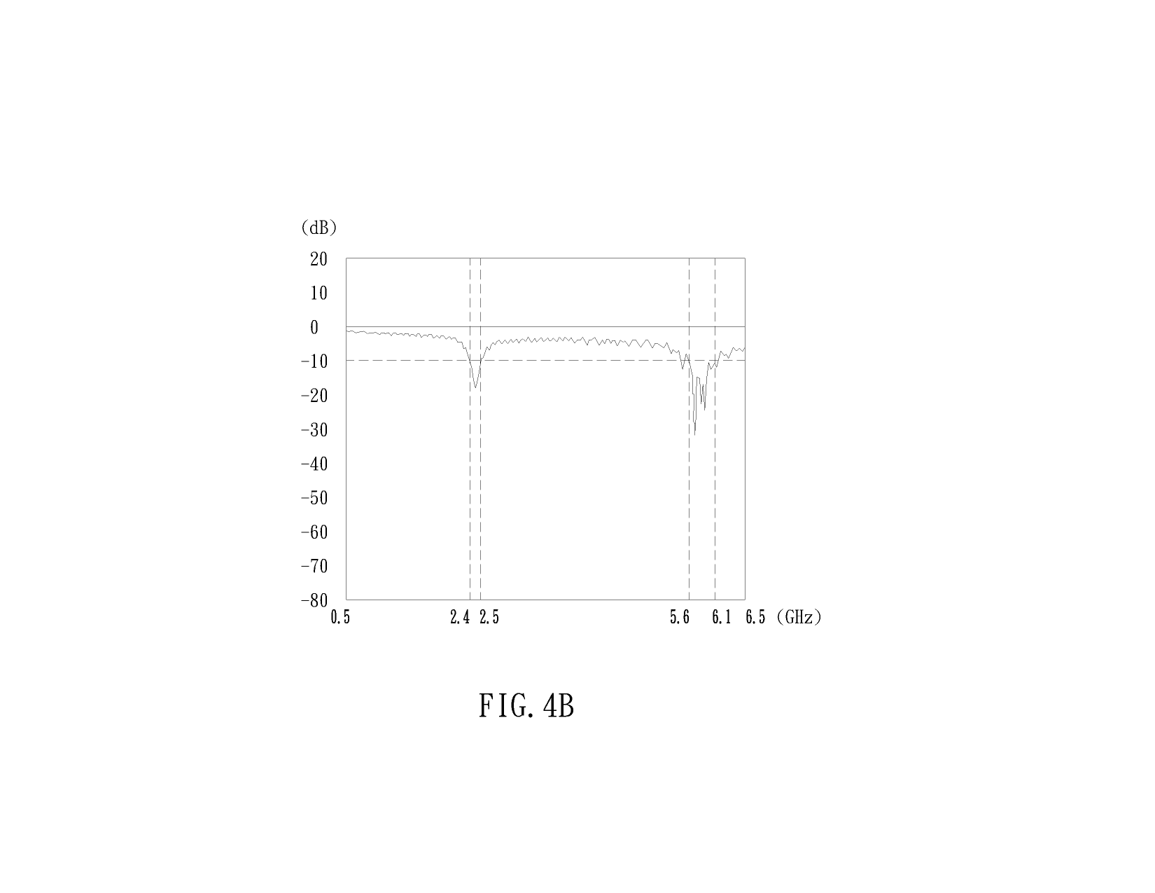

Please refer to FIG. 4A and FIG. 4B, which respectively show the voltage standing-wave ratio (VSWR) and the return loss of the multi-band planar inverted-F antenna of FIG. 1. As the multi-band planar inverted-F antenna 100 of FIG. 1 is designed with IEEE802.11a and IEEE802.11b/g protocols that the operating frequency thereof is primarily ranged between 2400-2500 MHz and 5725-2825 MHz in respective, the VSWRs are kept to be smaller than 2 and the corresponding return losses are all smaller than −10 dB while operating in both aforesaid ranges that satisfy a common standard, as seen in FIG. 4A and FIG. 4B.

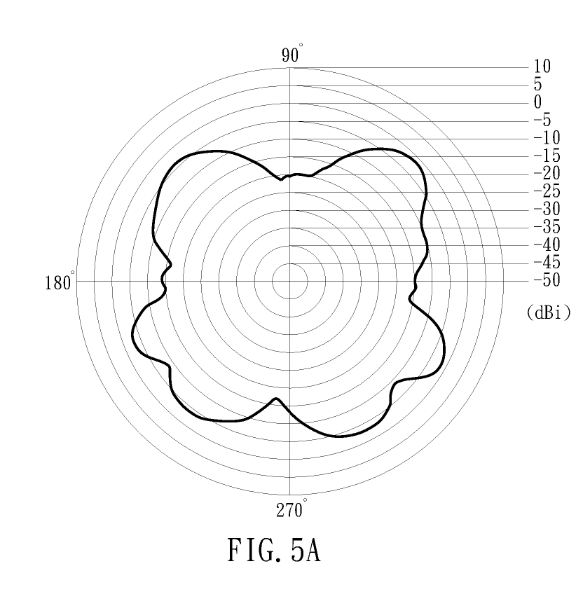

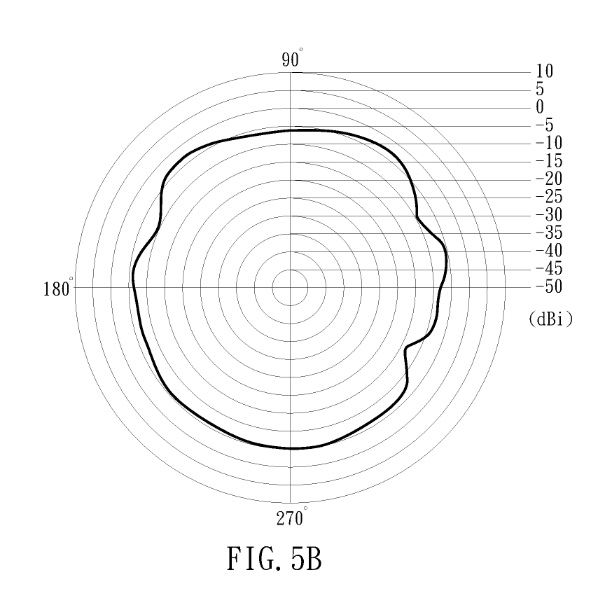

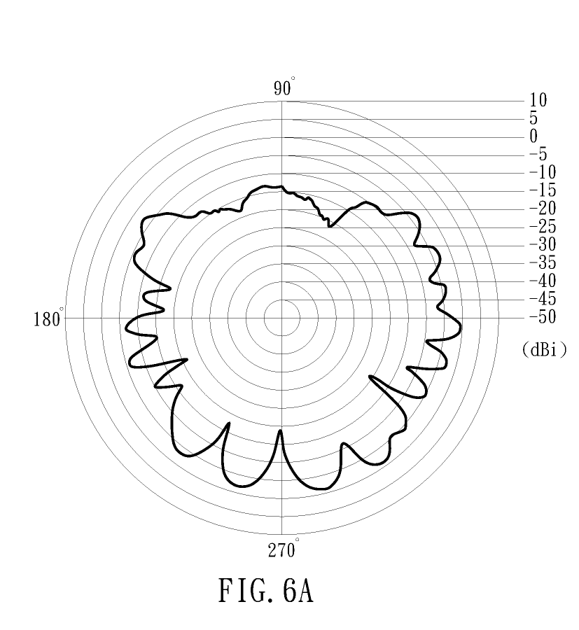

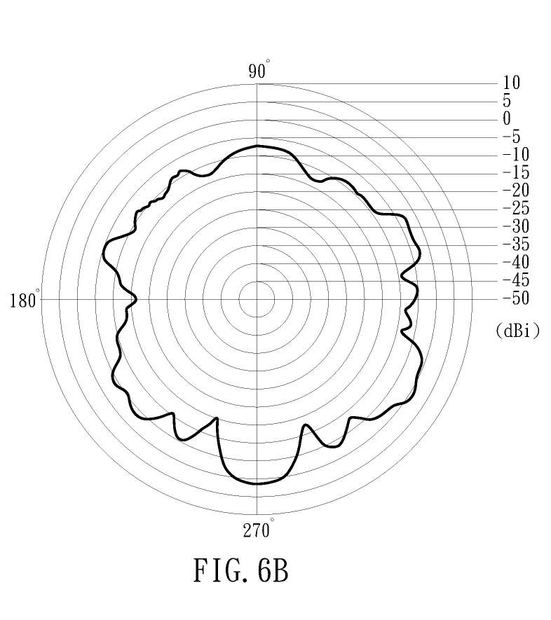

Please refer to FIG. 5A and FIG. 5B, which respectively shows the radiation patterns of H-plane multi-band planar inverted-F antenna of FIG. 1, operating at 2450 MHz, and the radiation patterns of E-plane multi-band planar inverted-F antenna of FIG. 1, operating at 2450 MHz. Please refer to FIG. 6A and FIG. 6B, which respectively shows the radiation pattern of H-plane multi-band planar inverted-F antenna of FIG. 1, operating at 5800 MHz, and the radiation pattern of E-plane multi-band planar inverted-F antenna of FIG. 1, operating at 5800 MHz. As seen in FIGS. 5A, 5B, 6A and 6B, the average gain of the multi-band planar inverted-F antenna 100, operating at 2450 MHz and 5800 MHz, can all meet a common requirement.

To sum up, the multi-band planar inverted-F antenna of the invention has the following advantages:
(1)As the structure of the aforesaid multi-band planar inverted-F antenna is simple and thus is easy to be manufactured, it can be mass produced with high yield.
(2)The impedance matching between the feeding port 110 and the connecting port 150 can be adjusted easily so that the transmission quality of the multi-band planar inverted-F antenna 100 is improved.
(3)As the number of the radiation areas to be designed in the antenna is determined by the frequencies that are intended to be received/transmitted thereby, the multi-band planar inverted-F antenna can be enabled to transmit/receive multiple band of frequency by designing multiple radiation areas in the antenna.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A multi-band planar inverted-F antenna, adapted for a wireless communication comprising:
a feeding port, connected to the wireless communication device;
a first radiation area, connected to the feeding port;
a second radiation area, connected to the feeding port while arranged at a side the same as that of the first radiation area with respect to the feeding port;
a ground area; and
a connecting port, connected to the ground area and the feeding port while being arranged at a side opposite to the first radiation area with respect to the feeding port.

2. The multi-band planar inverted-F antenna of claim 1, wherein the connecting port is connected to a corner of the ground area.

3. The multi-band planar inverted-F antenna of claim 1, wherein the length of the first radiation area is not equal to that of the second radiation area.

4. The multi-band planar inverted-F antenna of claim 1, wherein the width of the first radiation area is equal to that of the second radiation area.

5. The multi-band planar inverted-F antenna of claim 1, wherein the width of the first radiation area is not equal to that of the second radiation area.

6. The multi-band planar inverted-F antenna of claim 1, wherein the first radiation area can be designed with various widths.

7. The multi-band planar inverted-F antenna of claim 1, wherein the second radiation area can be designed with various widths.

8. The multi-band planar inverted-F antenna of claim 1, further comprising:
a third radiation area, connected to the feeding port while arranged at a side the same as that of the first radiation area with respect to the feeding port.
